(19) United States
(12) Patent Application Publication
(10) Pub. No.: US 2008/0242147 A1
(43) Pub. Date: Oct. 2, 2008

(54) Headset with data connector

(75) Inventors: Nir J. Warkrat, Santa Clara, CA (US); Donald J. Novotney, San Jose, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: (Apple, Inc.)

(21) Appl. No.: 11/731,352

(22) Filed: Mar. 29, 2007

(51) Int. Cl. H01R 13/648

(52) U.S. Cl. 439/607

(57) ABSTRACT

This application is directed to a headset having an integrated data connector (e.g., a USB female connector). The headset may include an electronic device interfacing portion that may include a USB male connector and a 3.5 mm jack for engaging an electronic device. The headset may also include an acoustic portion that may include at least acoustic element (e.g., speaker) and a USB female connector. To connect the electronic device to a host device (e.g., to transfer music files or recharge the electronic device's battery), the USB connector of the electronic device interfacing portion can engage the host device. To provide audio to a user, the USB connector of the acoustic portion can engage the electronic device interfacing portion, which provides a path from the electronic device to the acoustic element for audio signals. This approach allows a user to use a single cable for connecting the electronic device to both the host device and the acoustic element.

### BACKGROUND OF THE INVENTION

This invention is directed to headphones with an integrated data connector.

Some existing electronic devices allow users to connect a headset to the electronic device for listening to audio. Some existing electronic devices also include a port for connecting the electronic device to a host device using a transfer cable coupled to the electronic device and host device. Using the transfer cable, the user may recharge the electronic device and/or transfer data, for example media files, from the host device to the electronic device. This approach requires the user of the electronic device to keep track of two accessories: the headset for listening to audio and the transfer cable for connecting to the host device.

Although many users may be diligent in keeping track of both accessories, users may not necessarily carry both with them. For example, users of a personal media player (e.g., an iPod or iPod Shuffle) may carry only the headset, and find themselves without a transfer cable for recharging the personal media player when they travel. Other users may simply misplace the less-used transfer cable, and be forced to replace it at an additional expense.

Accordingly, it would be desirable to provide a system to assist users in keeping track of the headset and of the transfer cable.

### SUMMARY OF THE INVENTION

A system by which both the headset and the transfer cable are integrated in a single unit is provided. This system can assist users in keeping track of the headset and of the transfer cable.

In accordance with some embodiments of the invention, a transfer cable that has a first data connector is provided (e.g., a male USB connector). The transfer cable can also include a second data connector, for example a 3.5 mm jack, for coupling the transfer cable to the electronic device. The first data connector of the transfer cable may then be used to connect to a host device to provide power and data transfers. In some embodiments, the data connector may be used to connect to a power supply (e.g., using a converter) to provide power for recharging the electronic device.

To avoid the risk of misplacing the transfer cable, an acoustic portion can be provided such that the acoustic portion may be connected to the transfer cable, and thus to the electronic device, without decoupling the transfer cable from the electronic device. The combination of the acoustic portion and the transfer cable can form the headset, although other elements may be present as well. To connect to the transfer cable, the acoustic portion can include a third data connector (e.g., a female USB connector) opposite the acoustic portion speakers. The third data connector can be coupled to the first data connector to allow audio signals to pass from the electronic device through the jack of the transfer cable, across the data connector connection (e.g., a USB connector connection), and into the acoustic portion speakers.

The signals transmitted by the transfer cable and by the acoustic portion may be associated with any suitable combination of contact regions or pins of the data connectors. For example, the left and right audio signals may be associated with pins and jack contact regions that correspond to up and downstream data transfers.

Providing a headset with a data connector can greatly reduce the risk of users losing the transfer cable because the transfer cable is always used. It can be directly connected to a host device for data and power transfers or connected to the acoustic portion for providing audio to the user.

The embodiments of the invention are of particular use for electronic devices that use a single port for data and power transfers and for audio signals. For example, one such device is the iPod Shuffle, from Apple, Inc. of Cupertino, Calif. Using the present invention, such electronic devices may combine the use of cables or wires to provide a more efficient system. On the other hand, electronic devices that use different ports for power and data transfers typically cannot take advantage of some of the benefits of the present invention, as the same port, and therefore the same cable, is not used for both data transfers and audio signals.

The first, second and third data connectors may be any suitable connectors or interfaces usable for the transfer cable and for the headset. For example, a Firewire connector may be used to connect the transfer cable to the headset. As another example, a USB connector may be used instead of a jack for the transfer cable, or the transfer cable may be permanently fixed to the electronic device (e.g., a cable that permanently extends from the electronic device).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a perspective view of an illustrative headset in accordance with one embodiment of the present invention;

FIG. 2A is a perspective view of a USB A female connector in accordance with one embodiment of the present invention;

FIG. 2B is a perspective view of a USB A male connector in accordance with one embodiment of the present invention;

FIG. 3 is a perspective view of a 3.5 mm jack in accordance with one embodiment of the present invention;

FIG. 4 is a table showing associations of USB pins and jack connectors with signal names in accordance with one embodiment of the present invention;

FIG. 5 is a table showing associations of USB pins and jack connectors with signal names for a headset in accordance with one embodiment of the present invention;

FIG. 6A is a schematic view of an electronic device connected to a host device in accordance with one embodiment of the present invention;

FIG. 6B is a schematic view of an electronic device connected to a headset in accordance with one embodiment of the present invention;

FIG. 7 shows an illustrative flowchart of a process for using the headset to connect either to a host device or to an acoustic device in accordance with one embodiment of the present invention; and

FIG. 8 shows an illustrative flowchart of a process for using the headset to connect first to a host device and then to an acoustic device in accordance with one embodiment of the present invention.

### DETAILED DESCRIPTION

In accordance with the present invention, a headset with a USB female connector is provided.

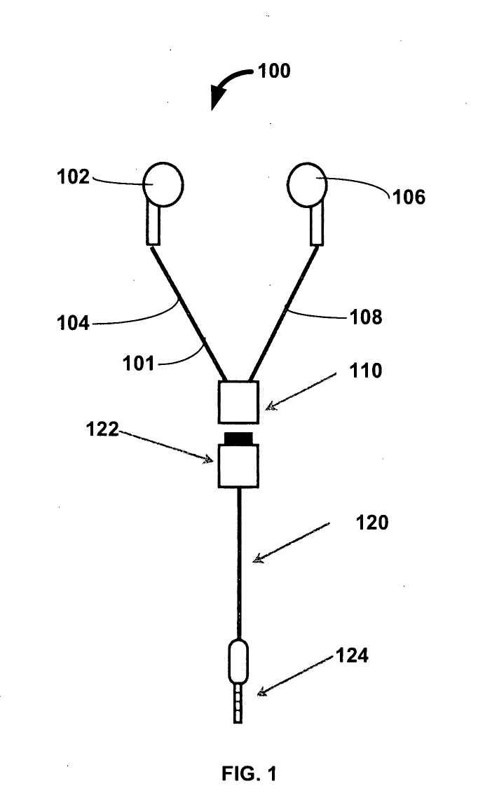

FIG. 1 shows a perspective view of an illustrative headset in accordance with one embodiment of the present invention. Headset 100 can include acoustic portion 101 and transfer cable 120 (e.g., an electronic device interfacing portion). Acoustic portion 101 can include left acoustic speaker 102 and right acoustic speaker 106. Left cable 104, which can be connected to left speaker 102 and right cable 108, which can be connected to right speaker 106, may be connected to USB A female connector 110. Acoustic portion 101 can be connected to an electronic device using transfer cable 120. Transfer cable 120 may include USB A male connector 122 at the first end, and another connector, for example 3.5 mm headphone jack 124, at the second end of transfer cable 120.

In some embodiments, transfer cable 120 may be configured to provide for power and data transmission as well as audio signals. Accordingly, jack 124 may include sufficient contact regions for transmitting power, data and audio. Jack 124 may include a single prong or multiple prongs, where each prong may include one or more contact regions.

Acoustic portion 101 can include a stereo headset that includes left and right acoustic speakers or a mono headset that provides audio using a single signal. Acoustic portion 101 can also include an integrated microphone. To activate a function, for example with respect to the microphone, acoustic portion 101 or transfer cable 120 can further include an embedded switch. Acoustic portion 101 may include any suitable acoustic element such as, for example, an earbud, a headphone, a speaker, or any other suitable acoustic element. Some of these features are discussed in more detail in commonly assigned U.S. application Ser. No. 11/650,001, filed Jan. 5, 2007 (P4640US1) and U.S. Provisional Patent Application No. 60/879,155, filed Jan. 6, 2007 (P5021US1), both of which are incorporated by reference herein in their entirety.

Transfer cable 120 and acoustic portion 101 may be any suitable length. For example, when transfer cable 120 and acoustic portion 101 are coupled, the resulting headset length may be 36 inches. Transfer cable 120 may then be 21 inches long, for example, and acoustic portion 101 may be 15 inches long. Any other distribution for the lengths of transfer cable 120 and acoustic portion 101 may be used (e.g., transfer cable 120 length and acoustic portion 101 length may be in the 12 inch-24 inch range). In some embodiments, the coupled transfer cable 120 and acoustic portion 101 may have a length that falls within the range of 12 inches and 60 inches, and any suitable distribution of lengths for transfer cable 120 and acoustic portion 101 may be used.

Transfer cable 120 may be coupled with an electronic device to transmit audio signals from the electronic device to speakers 102 and 106. Transfer cable 120 may use any suitable connector for coupling to the electronic device. In the example of FIG. 1, jack 124 can be used. However, any other suitable connector, such as for example a USB connector, a Firewire connector (IEEE 1394), a 2.5 mm jack, a 3.5 mm jack, or any other suitable connector may be used (e.g., any suitable data connector). In some embodiments, transfer cable 120 may be permanently fixed to the electronic device. For example, cable 120 may be included in the circuitry of the electronic device, or USB male connector 122 may be directly connected to the circuitry of the electronic device (e.g., extending directly from the device).

In some embodiments, other interface types can be used for connectors 110, 122 and jack 124. Such interface types may include, for example, USB A, USB B, USB Mini-A, USB Mini-B, Micro-USB, Firewire (IEEE 1394), SCSI, parallel port, serial port, 2.5 mm jack, 3.5 mm jack, 4.5 mm jack, or any other suitable interface or connector type. The connectors may be of any suitable size. For example, the male connector may have a ½× 3/16 inch cross section, and the female connector may have a ⅝× 5/16 cross section. As another example, the male and female connectors may have cross sections that are within the range of 1/16× 1/16 inch and 1×1 inch. In some embodiments, the connectors may have non-rectangular cross sections (e.g., trapezoidal, circular, elliptical, or combinations thereof).

The pins or contact regions of connectors 110 and 122 and jack 124 may be associated with different signals in any suitable manner. In particular, different pins or contact regions may be used to transmit power, ground, audio, and data signals. The following discussion will serve to illustrate an exemplary distribution of signals with pins and contact regions using USB A connectors 110 and 122, and 3.5 mm jack 124. It will be understood however that any other suitable connector or interface may be used (e.g., data connector or other connector type).

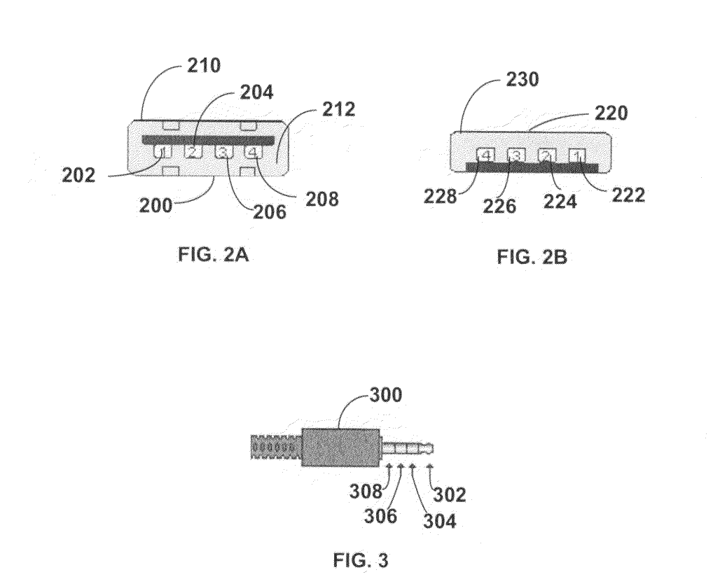

FIG. 2A shows a perspective view of the components of an illustrative USB A female connector. USB A female connector 200 can include pins 202, 204, 206 and 208. The pins may be protected by shell 210, which may prevent external forces from deforming or breaking the pins. Free space 212 between pins 202, 204, 206 and 208 and shell 210 may be configured to receive the outer periphery of a counterpart USB A male connector.

FIG. 2B shows a perspective view of the components of an illustrative USB A male connector. UBS A male connector 220 can include pins 222, 224, 226 and 228. The pins may be protected by shell 230, which covers the pins in a manner similar to the manner in which shell 210 may protect the pins of connector 200. Shell 230 and free space 232, which can be enclosed by shell 230, may be configured such that connector 220 may be electrically coupled to connector 200.

When connector 200 is coupled to connector 220, shell 230 and free space 232 may be configured to fit in free space 212 such that connectors 200 and 220 may be in a closely fitting relation. In addition, pins 202, 204, 206 and 208 may be configured to engage pins 222, 224, 226 and 228, respectively, such that a signal may pass across the connectors 200 and 220 through the engaged pins. In FIGS. 2A and 2B, pins 202, 204, 206, 208, 222, 224, 226 and 208 are identified by numbers 1 to 4. The pins of connectors 200 and 220 may be distributed and aligned such that opposing pins identified by the same number engage.

FIG. 3 is a perspective view of an illustrative jack. 3.5 mm jack 300 can include contact regions 302, 304, 306 and 308. Each of the contact regions may be configured to transmit a particular signal. For example, one contact region may be configured to transfer power across jack 300 into an electronic device (e.g., to recharge a battery). In some embodiments, the contact regions may be configured to be specific to a particular signal.

The signals provided by an electronic device coupled to a transfer cable (e.g., transfer cable 120, FIG. 1) or to a transfer cable combined with an acoustic portion (e.g., acoustic portion 101, FIG. 1) may be assigned to the pins and contact regions of connectors 200 and 220 and jack 300 in any suitable manner. The following tables provide an illustrative distribution of signals to the pins and contact regions of the connectors and jack. It will be understood, however, that any other suitable distribution of signals may be used.

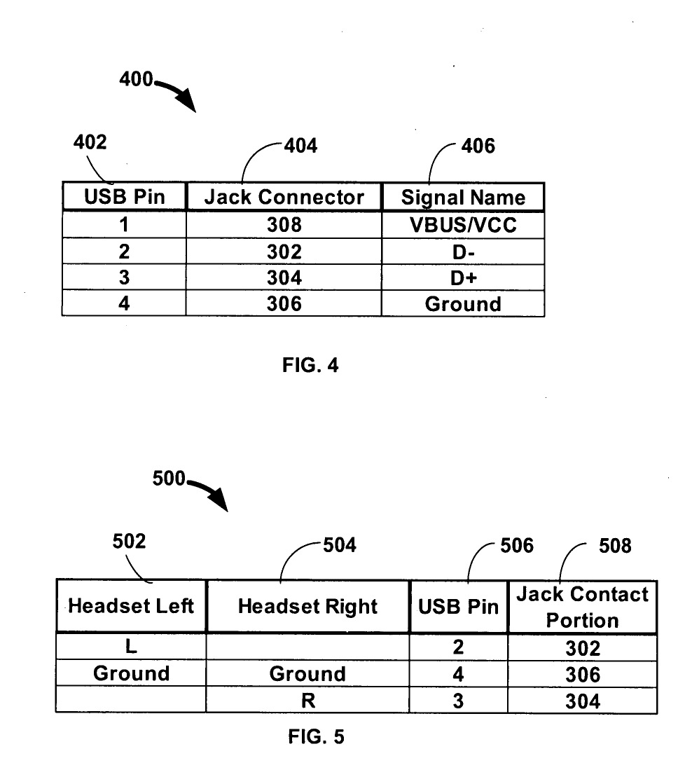

FIG. 4 shows illustrative table 400 that identifies the signals associated with the pins of connectors 200 and 220, and with the contact regions of jack 300 for data and power transfers (e.g., when transfer cable 120 of FIG. 1 is connected to a host device). Table 400 includes columns 402, 404 and 406. Column 402 identifies the pin of USB connectors 200 and 220 (identified by numbers 1-4 in FIGS. 2A and 2B), column 404 identifies the contact region of jack 300, and column 406 identifies the signal carried by a cable connecting the pin and contact of a same line of the table. In the illustrative distribution of FIG. 4, USB pin 1 and contact region 308 may transfer the VCC signal (e.g., power). USB pin 2 and contact region 302 may transfer the D+ signal, and USB pin 3 and contact region 304 may transfer the D− signal (e.g., upstream and downstream data). USB pin 4 and contact region 306 may transfer the ground signal.

FIG. 5 shows illustrative table 500 that identifies the signals associated with the pins of connectors 200 and 220, and with the contact regions of jack 300 for audio signal transmissions (e.g., when transfer cable 120 of FIG. 1 is connected to headset 100 of FIG. 1). Table 500 includes columns 502, 504, 506 and 508. Column 502 identifies the audio signal transmitted to the left speaker of the headset (e.g., left speaker 102, FIG. 1) and column 504 identifies the audio signal transmitted to the right speaker of the headset (e.g., right speaker 106, FIG. 1). Column 506 identifies the pin of USB connectors 200 and 220 (identified by numbers 1-4 in FIGS. 2A and 2B), and column 508 identifies the contact region of jack 300. In the illustrative distribution of FIG. 5, USB pin 2 and contact region 302 may transmit the left audio signal and USB pin 3 and contact region 304 may transmit the right audio signal. USB pin 4 and contact region 306 may transmit the ground signal to both headset speakers. In the example of FIG. 5, there is no transmission of power to the headset, and accordingly USB pin 1 and contact region 308 may not be used. In some embodiments, however, the unused pins and contact regions may be used to transmit power, microphone audio, or any desired signal.

In some embodiments, electric static discharges, electromagnetic interferences, power fluctuations, or other such effects may be created when a user connects connector 110 to connector 122 (FIG. 1) or connector 200 to connector 220 (FIGS. 2A and 2B). These effects may cause short circuits in the connectors, undesired signals to be transmitted or even damage to the connectors or cables and wires (e.g., transfer cable 120 of FIG. 1 or cables 104 and 108 of FIG. 1). To protect the system from these effects, appropriate filters may be installed or incorporated in one or both of the connectors (e.g., connectors 100, 122, 200 and 220).

One application for embodiments of the present invention may be electronic devices that are configured to connect both to a host device for power transfers, data transfers, or both, and to a headset for audio capability. One such device is the iPod Shuffle, from Apple, Inc. of Cupertino, Calif. The Shuffle may include a single 3.5 mm jack which is used for both audio playback and for connecting to a host device (e.g., a computer) for power and data transfers. To connect to the host device, a cable other than the headset can be connected to the 3.5 mm jack and can be plugged into the host device (e.g., using a USB connection). Thus two cables may be required: a first cable that includes earphones and a 3.5 mm jack for listening to music, and a second cable with a USB connector and a 3.5 mm jack for transferring data and for recharging the electronic device's battery. Having two cables used for different purposes may become frustrating for users, as a user who misplaces the second cable (i.e., the data and power transfer cable) can no longer recharge the electronic device or change the stored media (e.g., the songs stored in the Shuffle).

Embodiments of the present invention may eliminate this frustration for users. By providing an acoustic portion with a USB connector, the second cable, used to connect the electronic device to the host device, may also be used for the headset. Thus, the second cable for connecting to a host device may always be available to the user.

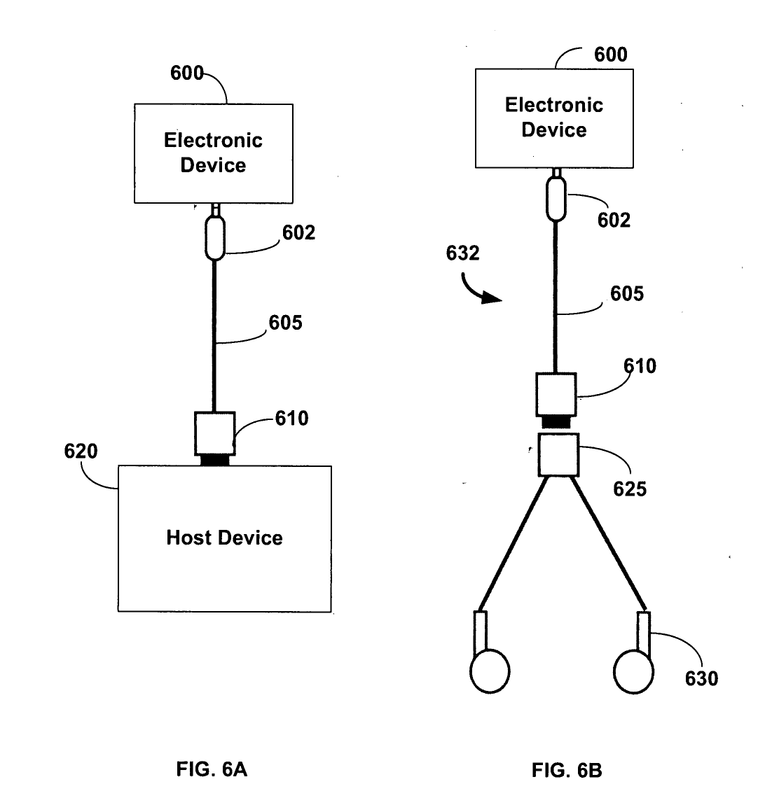

FIGS. 6A and 6B illustrate this feature of the present invention. FIG. 6A includes electronic device 600 and host device 620. Electronic device 600 can include a single port that may be configured to receive jack 602 for data and power transmission. Jack 602 may be connected to USB A male connector 610 via cable 605. Electronic device 600 may be connected to host device 620 by connecting jack 602 to electronic device 600 and USB connector 610 to host device 620. Using cable 605, power and data can be transmitted from host device 600 to electronic device 600 (e.g., to recharge the battery of electronic device 600 and to transfer music files from a library on host device 620 to electronic device 600).

FIG. 6B includes electronic device 600 and acoustic portion 630. As in FIG. 6A, electronic device 600 may be connected to cable 605 using jack 602. To provide audio to the user, acoustic portion 630 can be engaged with USB connector 610 using USB A female connector 625 to form headset 632. By providing acoustic portion 630 with USB female connector 625, cable 605 may remain coupled to electronic device 600 when the user listens to audio signals transmitted by electronic device 600, thus reducing the risk of misplacing cable 605.

The embodiment of FIGS. 6A and 6B, the connectors described use USB A and 3.5 mm jack interfaces. It will be understood, however, that any other interface or connector type may be used for any of electronic device 600, connectors 610 and 612, jack 602, and host device 620.

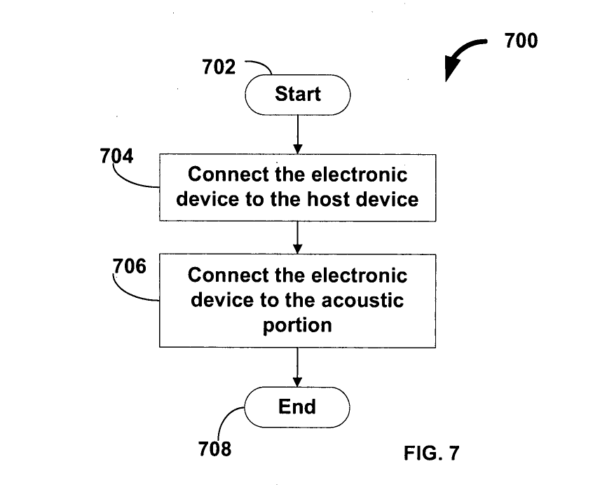

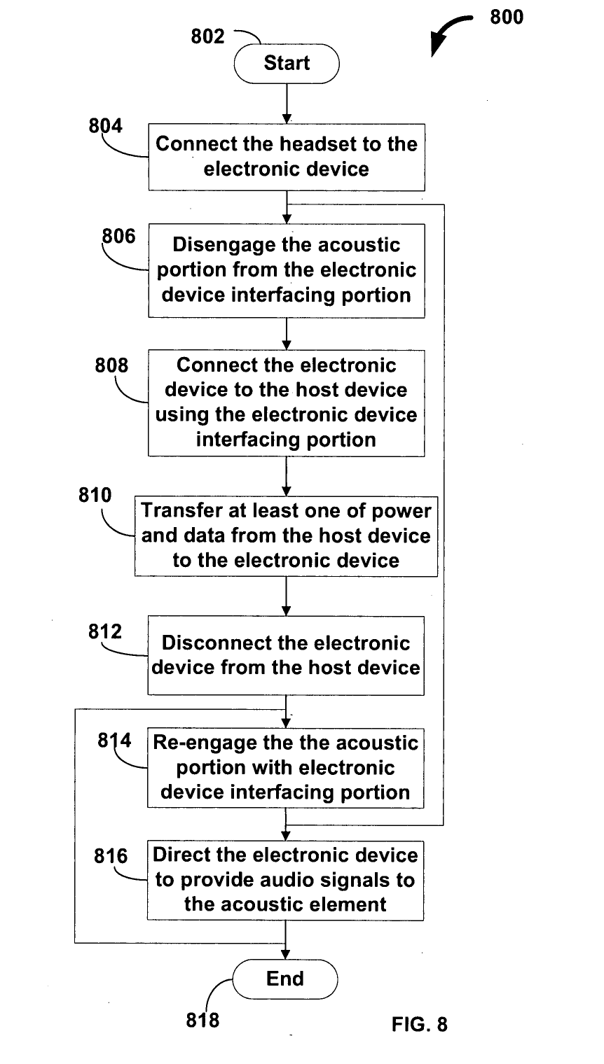

FIGS. 7 and 8 show illustrative flowcharts of processes for using embodiments of the present invention. FIG. 7 shows an illustrative flowchart of a process for using the headset to selectively connect an electronic device to either a host device or an acoustic portion of the headset. The headset may be formed from the combination of an electronic device interfacing portion and an acoustic portion that may be coupled using connectors (e.g., USB connectors) located on each of the portions. The electronic device interfacing portion may include a connector for coupling the interfacing portion to the electronic device. The acoustic portion may include at least one acoustic element for providing audio. Process 700 begins at step 702. At step 704, the electronic device is connected to the host device. For example, the electronic device interfacing portion may be connected to the electronic device and to the host device. The electronic device interfacing portion may include a data connector, for example a male USB connector, for coupling to the host device. At step 706, the electronic device is coupled to the acoustic portion. For example, the electronic device interfacing portion, which is coupled to the electronic device, may be coupled to the acoustic portion. The electronic device interfacing portion may include a male USB connector that is configured to engage a female USB connector of the acoustic portion. In some embodiments, the electronic device interfacing portion may first need to be disconnected from the host device before engaging the acoustic portion. Process 700 then ends at step 708.

FIG. 8 shows an illustrative flowchart of a process for using the headset to connect an electronic device first to a host device and then to an acoustic portion of the headset. Process 800 begins at step 802. At step 804, the user may connect the headset to the electronic device. For example, the user can connect the connector of the electronic device interfacing portion (e.g., a jack) to the electronic device. At step 806, the acoustic portion may be disengaged from the electronic device interfacing portion. For example, the user may disengage USB connectors that are located on each of the interfacing and acoustic portions. At step 808, the electronic device may be connected to the host device using the electronic device interfacing portion. For example, a user may connect the USB connector of the interfacing portion to a USB port in a host device (e.g., a computer). At step 810, at least one of data and power may be transferred from the host device to the electronic device. In some embodiments, at least one of data and power may also be transferred from the electronic device to the host device. For example, a user may select a function on the host device that causes the host device to transfer media files to the electronic device (e.g., transfer media files to an iPod using iTunes).

At step 812, the electronic device may be disconnected from the host device. For example, the user may disengage the USB connector of the electronic device interfacing portion from the host device. At step 814, the acoustic portion may be re-engaged with the electronic device interfacing portion. For example, the user may engage the USB male connector of the electronic device interfacing portion with the USB female connector of the acoustic portion. At step 816, the electronic device may be directed to provide audio signals to the acoustic element of the acoustic portion. For example, the user may provide a “play” instruction on the electronic device. The audio signals can then be transmitted by the electronic device interfacing portion and by the acoustic portion to the acoustic element. Process 800 then ends at step 818.

In some embodiments, a number of steps in process 800 may be skipped, depending on the user's intent. For example, if a user wishes simply to listen to music using the electronic device, the user may only perform steps 804 and 816. As another example, if a user wishes only to recharge the electronic device, the user may only perform steps 804, 806, 808 and 810. A few of these alternatives are identified by additional arrows in FIG. 8. In addition, the order of the steps may be changed. It will be understood, therefore, that process 800 may include fewer steps, and that the order of the steps may be any suitable order.

The above described embodiments of the present invention are presented for purposes of illustration and not of limitation, and the present invention is limited only by the claims which follow.

What is claimed is:

1. A headset comprising:
at least one acoustic speaker;
a USB female connector; and
a cable connecting the at least one acoustic speaker to the USB female connector.

2. The headset of claim 1, wherein the USB female connector is one of a USB A, USB B, mini USB A, mini USB B, and micro USB female connector.

3. The headset of claim 1, wherein the USB female connector comprises a plurality of pins or contact regions, at least two of which are electrically coupled to the at least one acoustic speaker.

4. The headset of claim 1, wherein the USB female connector comprises at least one of an electric static discharge filter, an electromagnetic interference filter, and a power supply filter.

5. A headset comprising:
an electronic device interfacing portion comprising a jack and a first connector; and
an acoustic portion comprising at least one acoustic element and a second connector, the second connector constructed to engage the first connector.

6. The headset of claim 5, wherein the first connector is a female connector and the second connector is a male connector.

7. The headset of claim 5, wherein the first and second connectors are data and power connectors.

8. The headset of claim 5, wherein the first connector is a USB female connector and the second connector is a USB male connector.

9. The headset of claim 5, wherein the first connector is constructed to engage an electronic device.

10. The headset of claim 9, wherein the electronic device is a host device.

11. The headset of claim 5, wherein the jack is constructed to engage an electronic device.

12. The headset of claim 5, wherein the at least one acoustic element is a speaker.

13. The headset of claim 5, wherein the at least one acoustic element is an earbud.

14. The headset of claim 5, wherein in an acoustic transmission mode, the electric interfacing portion and the acoustic portion are electrically coupled together.

15. The headset of claim 5, wherein in a non-acoustic transmission mode, the electric interfacing portion and the acoustic portion are disconnected.

16. For use with a system comprising a host device and an electronic device, a headset for media and data transmission, comprising:
an electronic device interfacing portion comprising a first connector and a second connector; and
an acoustic portion comprising a third connector and an acoustic element, wherein:
the first connector is configured to be electrically coupled to the electronic device;
the second connector is configured to engage the host device to transmit at least data between the electronic device and the host device; and
the second connector is configured to engage the third connector to transmit audio signals from the electronic device to the acoustic element.

17. The headset of claim 16, wherein the second connector is a male connector and the third connector is a female connector.

18. The headset of claim 16, wherein the second connector is a USB male connector and the third connector is a USB female connector.

19. The headset of claim 16, wherein the first connector is a jack.

20. The headset of claim 16, wherein the at least one acoustic element is a speaker.

21. The headset of claim 16, wherein the at least one acoustic element is an earbud.

22. The headset of claim 16, wherein the second connector has a cross section of ½× 3/16 inch and the third connector has a cross section of ⅝× 5/16 inch.

23. The headset of claim 16, wherein the electronic device interfacing portion has a length within the range of 12 inches and 24 inches, and the acoustic portion has a length within the range of 12 inches and 24 inches.

24. A system for media transmission, comprising:
an electronic device; and
a headset comprising:
an electronic device interfacing portion comprising a first connector and a second connector; and
an acoustic portion comprising a third connector and an acoustic element, wherein:
the first connector is configured to be coupled to the electronic device; and
the second connector is configured to engage the third connector.

25. The system of claim 24, wherein the electronic device is configured to transmit audio signals to the acoustic element through the electronic device interfacing portion and through the acoustic portion.

26. The system of claim 24, wherein the first connector is a jack.

27. The system of claim 24, wherein the second and third connectors are USB connectors.

28. The system of claim 24, wherein the second connector is a male connector, and the third connector is a female connector.

29. The system of claim 28, wherein the second connector has a cross-section of ½ inch by 3/16 inch, and the third connector has a cross section of ⅝ inch by 5/16 inch.

30. The system of claim 24, wherein the second connector is configured to engage a host device for at least one of power and data transfers.

31. The system of claim 30, wherein the electronic device interfacing portion is configured to transmit power, data signals, and audio signals.

32. The system of claim 31, wherein the electronic device comprises a port for receiving power, data signals, and audio signals.

33. The system of claim 24, wherein the first connector is configured to be permanently coupled to the electronic device.

34. The system of claim 24, wherein the electronic device is at least one of a personal media player and a cellular telephone.

35. A method for using a headset to selectively connect an electronic device to either a host device or an acoustic portion of the headset, the headset comprising an electronic device interfacing portion and the acoustic portion, the method comprising:
using the electronic interfacing portion to connect the electronic device to the host device; and
using the electronic interfacing portion and the acoustic portion to connect the electronic device to the acoustic portion.

36. The method of claim 35, wherein using the electronic interfacing portion to connect the electronic device to the host device further comprises using the electronic interfacing portion to connect the electronic device to the host device for at least one of data and power transmission.

37. The method of claim 35, wherein the electronic device interfacing portion comprises a USB male connector.

38. The method of claim 35, wherein the acoustic portion comprises a USB female connector.

39. The method of claim 35, wherein the host device is a computer.

40. The method of claim 35, wherein the electronic device is at least one of a personal media player and a cellular telephone.
